(19) United States
(12) Patent Application Publication
(10) Pub. No.: US 2009/0124108 A1
(43) Pub. Date: May 14, 2009

(54) Insertable card format

(75) Inventors: Timothy Elliott, Huntington Beach, CA (US); William Pat Price, Rhome, TX (US); Cuong V. Quach, Yorba Linda, CA (US); Marcus Apitz, Yorba Linda, CA (US)

Correspondence Address: Law Office of Scott C Harris Inc, PO Box 1389, Rancho Santa Fe, CA, 92067, US

(73) Assignee: Vizio, Irvine, CA (US)

(21) Appl. No.: 11/938,234

(22) Filed: Nov. 9, 2007

(51) Int. Cl. H01R 13/62; H01R 13/648; B23P 11/00

(52) U.S. Cl. 439/345; 29/428

(57) ABSTRACT

A housing and memory card, usable to store data, and where the operation connects directly to contacts on the memory devices that are housed within the card. The pinouts can be usb pinouts.

### BACKGROUND

Different kinds of removable memory cards may be used for different purposes. For example, a memory card may be inserted into a camera or a television to interface stored data between the card and the unit. The designs and layouts of these cards may have different formats.

### SUMMARY

The present application describes a special kind of memory card. In one embodiment, the memory card houses and interfaces with flash memory. The memory on the card may be used for interfacing with a video device.

### BRIEF DESCRIPTION OF THE DRAWINGS

In the figures:

FIG. 1 shows an exploded view of a memory card, showing the top and bottom cases, and the memory devices within the case;

FIG. 2 illustrates how an RFID chip can be placed within the case;

FIG. 3 illustrates the loading orientation for the chips within the card;

FIG. 4 illustrates a detail of the flash substrate that is used in the card;

FIG. 5 illustrates a detail of the openings in the device, and also illustrates the pin layout, and different chamfers for guiding the device into place;

FIG. 6 illustrates a detailed view of the chamfer in the mating connector shown in FIG. 3.

### DETAILED DESCRIPTION

The present application goes against the established teaching in the art and uses a card layout which has a pin-out and a special mechanical system that allows improved connection capability, and improved speed at which large files can be written to and written from flash memory, and also simplifies the scheme that is used to read the files during streaming. The card also includes special mechanical structures that facilitates its insertion and holding in place.

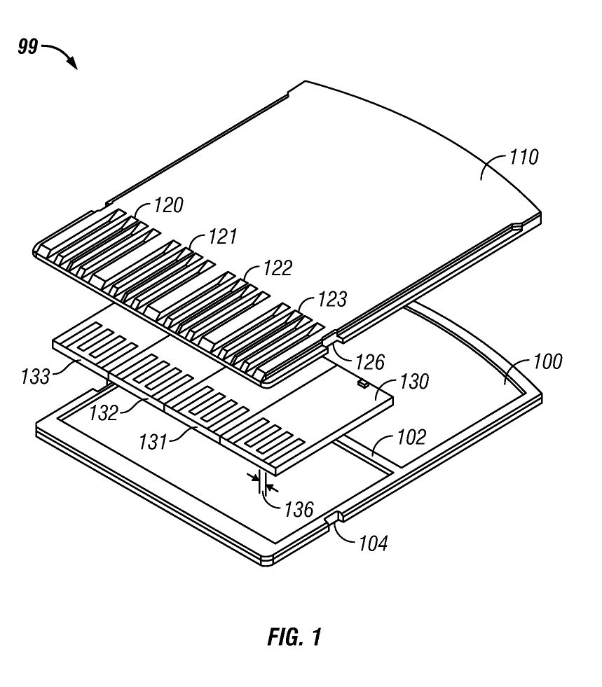

FIG. 1 illustrates an exploded view of the media card 99. The card is formed of two different plastic cases, a top case 100 which is substantially flat and has no openings therein, and a bottom case 110 which includes plural different connector portions 120, 121, 122, 123 therein. The connector portions, such as 120, each comprise a group of four connectors, which are spaced from one another. The spacing is at a special pitch that is the same as the pitch of spacing on a USB connector, here 2 mm. The connector groups themselves, however, such as 120 and 121 are spaced from one another by a second pitch that is different than the first pitch, and relates to the width of the memory devices 130 in the memory device layer, here 11.30 mm.

A number of different memory devices shown as 130, 131, 132, 133 are inside the media card. Each of the memory devices has its connectors showing through as connections of one of the connector groups. For example, the memory device 133 has connector layouts that connect to the connector 120. In the embodiment, four different memory devices are used, but it should be understood that any desired number of memory devices could be used. Also, while the card has room for 4 memory devices, a fewer number, such as 2 memory cards, could be placed in a reduced-memory configuration of the card.

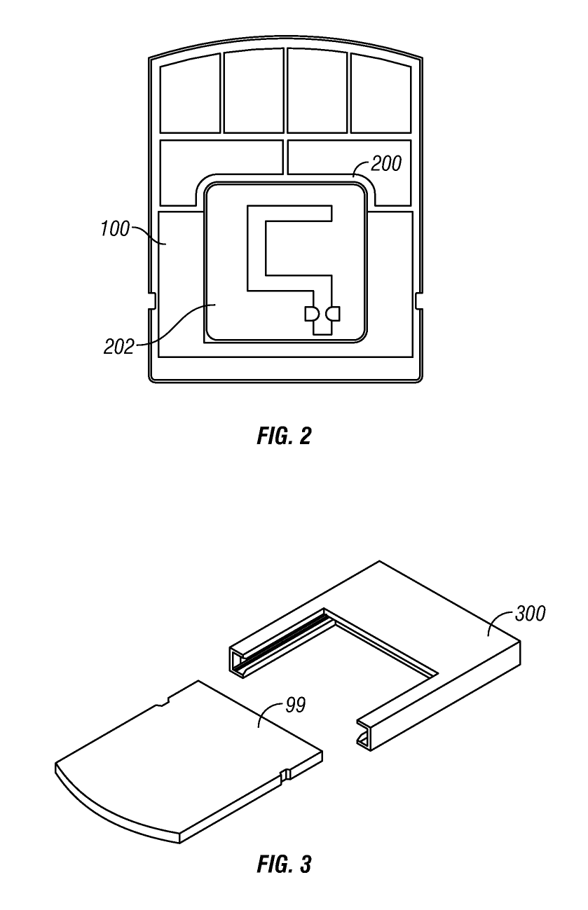

The top plastic case 100 also includes supporting ribs such as 102 which maintain the structural integrity of the device. The top plastic case 102 may also include an indented portion 200 as shown in FIG. 2. The indented portion 200 may include a spot for an RF ID chip 202, as shown in FIG. 2. The RFID chip can interface with the video player and allow the video to automatically ascertain contents of the chip, etc.

In addition, both the top case 100 and the bottom case 110 include indented portions 104 therein on the at least one side. The indented portion 104 and 126 form a retention notch that retains the card within the mating connector once inserted. The mating connector can use a spring detent to prevent the card from being easily removed, or can include a depressable knob to allow the removal of the card from the connector.

FIG. 3 illustrates how the card 99 can be inserted into a mating connector 300. The connector 300 holds the card with the contacts facing downward as explained further herein.

In an embodiment, the media card has four separate memory parts, and each memory part can be separately read, and can also be read simultaneously with the reading by any of the other cards. In an embodiment, each of the memories includes a USB 2.0 port. The memories may be separate chips, or may be a single chip with four separate ports. Each of the pin outputs of the memory 130-133 correspond to the pin outputs for a USB device. That is, the distance between the pins 136 is the exact distance between connectors in a USB device. In this embodiment, the USB substrates may be approximately 24.8 mm in height, 2 mm pitch between pins on the device, and each connector pin being approximately 1.1 mm in width.

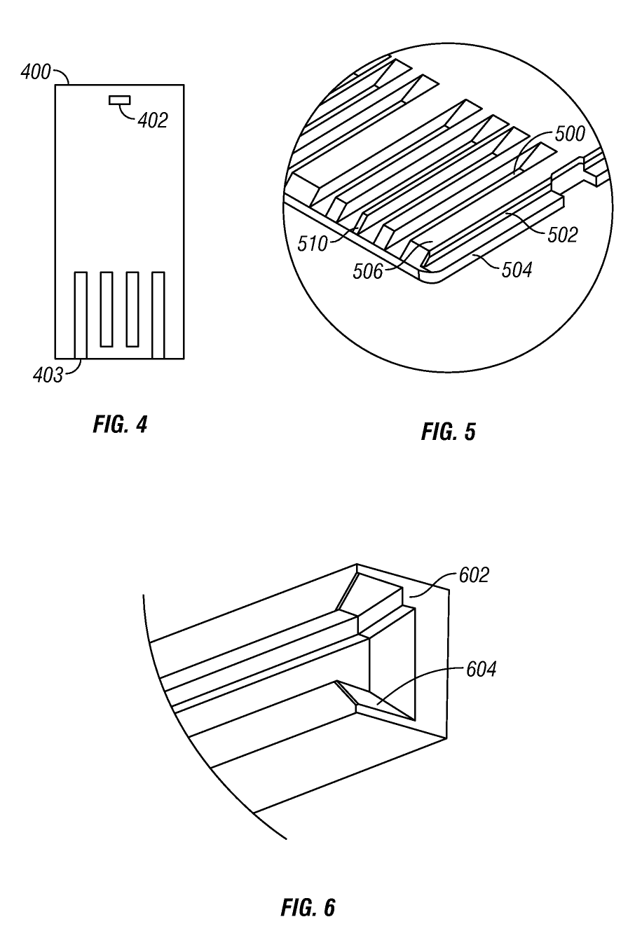

FIG. 4 illustrates the detailed pin-out of the connectors. Each USB memory device may also include an LED 402, which may be viewable through the housing device. When four of these devices are placed together, the contact configuration is as shown in FIG. 1.

While the above describes using a USB pen out, it should be understood that other pinouts can similarly be used. When a USB pin out is used, the flash memory devices art devices may be chip on board or COB. Other instances may use a printed circuit board with a USB to flash controller chip, and a number of flash memory chips. The above describes the pins in each group being identical to the pin layout for a USB connector. However, the pins may alternatively be used for serial ATA or IEEE 1394 pin configurations. One embodiment may use for pins for USB port, and seven of the remaining pins for a serial ATA port. One power of this package is that the single package can support multiple interfaces on the same package.

In an embodiment, the contacts on the device 400 may be gold contacts 403. The bottom case portion 110 may simply have cutouts that are in cut out at the right location to receive the mating contacts there are through. In this way, the bottom case simply allows contact by some other device directly to the memory chips therein.

FIG. 5 illustrates a detail of a portion of the bottom case, showing the cutouts 500, each cut out exposing a connector underneath. FIG. 5 also illustrates the chamfered area 502 in which the device is wider in cross-section towards its bottom 504 than it is in cross-section towards its top 506. This interfaces with a corresponding chamfer on the mating connector 300. FIG. 6 shows an illustration of the cross-section of this mating chamfer, and shows how the chamfer 502 mates with the chamfered mating portions 602. This prevents the device from being placed upside down into the corresponding connector. The lead in chamfer 604 provides a 45° slope surface so that the card can be more easily placed into its desired location.

The connector may also use a push push device, where the card is inserted to the end of its travel stroke. After insertion, a spring force allows the card to back off a little from its loaded location. Under pressure, the user can press the device against fat forced to release the card, and allow the car to move out of the connector some distance and be pulled out. A spring detent may also be placed in the connector to hold against the indentation 104.

Beveled edges are also located at the pin end of the device, shown generally as 510, to make sure that the connectors do not land on the wrong end when inserted.

This device ensures many advantages. Specifically, or by using multiple different groups of connectors, this allows connection to multiple different chips substantially simultaneously. Since the connection can be to multiple different chips, the different chips can be accessed all together and in parallel, and hence these chips can have a throughput that is many times greater than the throughput of only a single chip. In addition, the structure of the device that allows connection to the chips inside the connector to thereby allow a less expensive and more reliable connector since the connection is directly to the chip, and not through a proxy connection. In addition, the pin output, having groups of relatively closely connected pins, separated by a space, may be extremely advantageous.

The general structure and techniques, and more specific embodiments which can be used to effect different ways of carrying out the more general goals are described herein.

Although only a few embodiments have been disclosed in detail above, other embodiments are possible and the inventors intend these to be encompassed within this specification. The specification describes specific examples to accomplish a more general goal that may be accomplished in another way. This disclosure is intended to be exemplary, and the claims are intended to cover any modification or alternative which might be predictable to a person having ordinary skill in the art. For example, other kinds of medical imaging systems could be used with this embodiment. Other differences between the scans could be used. Other compensations can be applied to the scans.

Also, the inventors intend that only those claims which use the words “means for” are intended to be interpreted under 35 USC 112, sixth paragraph. Moreover, no limitations from the specification are intended to be read into any claims, unless those limitations are expressly included in the claims. The computers described herein may be any kind of computer, either general purpose, or some specific purpose computer such as a workstation. The computer may be an Intel (e.g., Pentium or Core 2 duo) or AMD based computer, running Windows XP or Linux, or may be a Macintosh computer. The computer may also be a handheld computer, such as a PDA, cellphone, or laptop.

The programs may be written in C or Python, or Java, Brew or any other programming language. The programs may be resident on a storage medium, e.g., magnetic or optical, e.g. the computer hard drive, a removable disk or media such as a memory stick or SD media, wired or wireless network based or Bluetooth based Network Attached Storage (NAS), or other removable medium or other removable medium. The programs may also be run over a network, for example, with a server or other machine sending signals to the local machine, which allows the local machine to carry out the operations described herein.

Where a specific numerical value is mentioned herein, it should be considered that the value may be increased or decreased by 20%, while still staying within the teachings of the present application, unless some different range is specifically mentioned. Where a specified logical sense is used, the opposite logical sense is also intended to be encompassed.

What is claimed is:

1. a memory device, comprising:
a first package portion, defining a substantially continuous portion with no openings therein;
a second package portion, defining plural different openings therein, wherein said plural different openings define a plurality of different groups of openings, a first group of openings having plural openings, each operative to allow connection to a connector inside the package, and each opening of said first group of openings having a first pitch therebetween, and wherein said plural different openings also define a second group of openings, also having said first pitch therebetween individual openings, and having a second spacing between said first group of openings and said second group of openings, said second spacing being larger than said first pitch; and
a plurality of memory devices, located between said top package portion and said bottom package portion, each memory device having connection parts that face towards said openings, and each memory device having a plurality of electrodes, spacings between the electrodes being the same as said first pitch, to allow connection to each of said electrodes from the outside of said package.

2. A device as in claim 1, further comprising an RFID chip, within said package, held therewithin.

3. A device as in claim 1, further comprising at least one orientation structure on an outer edge of said first package portion, extending in a direction substantially parallel to a direction of said electrodes, and being non-symmetrical, such that said memory device can only be inserted into a corresponding connector in a specified orientation.

4. A device as in claim 1, wherein said first pitch is substantially 2 mm, and said second spacing is greater than 2 mm.

5. A device as in claim 1, wherein said memory devices include an optical display thereon, which can be seen through said first package portion.

6. A method, comprising:
forming a package with a plurality of openings therein, said openings being spaced by a specified amount, and allowing connections through the openings to electrodes that can be connected to via the openings;
housing plural different memory chips within said package, wherein each of said memory chips has connectors thereon, and said connectors are spaced with the same pitch as a pitch between said openings in said package; and
allowing interface with and reading information from multiple ones of said memory chip simultaneously.

7. A method as in claim 6, wherein said memory chips are USB chips, and said pitches are a pitch between electrodes on the USB chip.

8. A method as in claim 6, wherein at least one of said memory chips is a USB chip, and at least one other of said memory chips is a chip of a different format than said USB chip.

9. A method as in claim 8, wherein said different format is a serial ATA format.

10. A method as in claim 6, wherein said allowing comprises interfacing with said chips using either a USB format by connecting to a first group of contacts using a USB format, or using a second format by connecting to a second group of said contacts using said second format.

11. A method as in claim 10, wherein said second format is serial ATA.

12. A method as in claim 6, wherein said package has four sets of four openings therein, and said allowing interface allows interface with four separate chips simultaneously using said four openings.

13. A method as in claim 6, further comprising placing an RF ID chip in said package.

14. An apparatus, comprising:
a package portion, having a top part having no openings therein,
a bottom part having openings therein, where said openings comprise openings through the package that extend to electrodes of memory devices that are located therein, and at least some of said openings have a pitch there between which corresponds to a pitch between electrodes on a USB device, and allows connections directly to a USB device;
a plurality of chips, within said package portion, said plurality of chips each having connectors thereon, and said connectors being connectable to via said openings in said package portion, wherein said connectors form a first set of connectors that allows a USB format connection, and a second set of connectors which allows a serial ATA connection directly to the memory chips.

15. An apparatus as in claim 14, further comprising RF ID chip in the package.
